(19) United States
(12) Patent Application Publication
(10) Pub. No.: US 2025/0250422 A1
(43) Pub. Date: Aug. 7, 2025

(54) Polyarylene Sulfide Composition With Improved Crystallization Properties

(71) Applicant: Ticona LLC, Florence, KY (US)

(72) Inventors: Yuehua Yu, Cincinnati, OH (US); Zhe Tan, Shanghai (CN); Fangfang Tao, Shanghai (CN)

(21) Appl. No.: 19/037,349

(22) Filed: Jan. 27, 2025

Related U.S. Application Data
(60) Provisional application No. 63/550,085, filed on Feb. 6, 2024.

(51) Int. Cl. C08K 9/06; C08K 5/544; C08K 5/548

(52) U.S. Cl. CPC C08K 9/06; C08K 5/544; C08K 5/548; C08K 2201/003; C08K 2201/019

(57) ABSTRACT

A polymer composition that comprises 100 parts by weight of a polymer matrix that contains a polyarylene sulfide and from about 30 parts by weight to about 120 parts by weight of inorganic fibers. The polymer composition exhibits a peak crystallization temperature (T_{p,c}) of about 230° C. or more and a tensile elongation of about 1.8% or more.

### RELATED APPLICATION

The present application is based upon and claims priority to U.S. Provisional Patent Application Ser. No. 63/550,085, having a filing date of Feb. 6, 2024, which is incorporated herein by reference.

### BACKGROUND OF THE INVENTION

Polyphenylene sulfide (“PPS”) is a high performance polymer that can withstand high thermal, chemical, and mechanical stresses. Due to its relatively slow crystallization rate, however, injection molding of parts from PPS can be challenging. For example, to achieve the desired degree of crystallization, molding is generally conducted at a high mold temperature (˜130° C. or more) and for a relatively long cycle time. Unfortunately, high mold temperatures typically dictate the need for expensive and corrosive cooling mediums (e.g., oils). Attempts to address the problems noted above have generally involved the inclusion of various additives in the polymer composition to help improve its crystallization properties. To date, however, such attempts have not been fully satisfactory. In fact, the problems have become even more pronounced as various industries (e.g., electronic, automotive, etc.) are now demanding injection molded parts with very small dimensional tolerances. In these applications, the polymer must have good flow properties so that it can quickly and uniformly fill the small spaces of the mold cavity. It has been found, however, that conventional polyphenylene sulfides that manage to meet the requisite high flow requirement tend to result in a significant amount of “flash” (excess polymeric material that is forced out of the cavity at the junction of two mold surfaces) during molding, especially when high temperatures/long cycle times are employed. The production of large amounts of flash can impact product quality, and also require the costly and time consuming step of trimming the part. As such, a need continues to exist for a polyarylene sulfide composition that can be more readily injection molded into parts having a variety of shapes and sizes.

### SUMMARY OF THE INVENTION

In accordance with one embodiment of the present invention, a polymer composition is disclosed that comprises 100 parts by weight of a polymer matrix that contains a polyarylene sulfide and from about 30 parts by weight to about 120 parts by weight of inorganic fibers. The polymer composition exhibits a peak crystallization temperature (T_{p,c}) of about 230° C. or more as determined by differential scanning calorimetry in accordance with ISO 11357-3:2018 and a tensile elongation of about 1.8% or more as determined at a temperature of 23° C. in accordance with ISO 527:2019.

Other features and aspects of the present invention are set forth in greater detail below.

### BRIEF DESCRIPTION OF THE FIGURE

A full and enabling disclosure of the present invention, including the best mode thereof to one skilled in the art, is set forth more particularly in the remainder of the specification, including reference to the accompanying FIGURE, in which:

FIG. 1 illustrates one embodiment of an apparatus that may be employed to injection mold the polymer composition of the present invention into a molded part.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a polymer composition that contains a polyarylene sulfide and a nucleation system that includes inorganic fibers. Although the exact mechanism is not fully understood, the present inventors have discovered that through selective control over the particular type and concentration of the inorganic fibers, the resulting composition can achieve excellent crystallization properties (e.g., rate of crystallization). In this regard, the improved crystallization rate can be characterized by a high peak crystallization temperature (T_{p,c}), such as about 230° C. or more, in some embodiments from about 232° C. to about 270° C., and in some embodiments, from about 235° C. to about 260° C., as determined by differential scanning calorimetry in accordance with ISO 11357-3:2018. Due to the improved crystallization rate, the polymer composition can be molded at lower temperatures to still achieve the same degree of crystallization. In addition to minimizing the energy requirements of the molding operation, the use of lower temperatures can also decrease the production of “flash” normally associated with high temperature molding operations. For example, the length of any flash (also known as burrs) created during a molding operation may be about 0.17 millimeters or less, in some embodiments about 0.14 millimeters or less, and in some embodiments, about 0.13 millimeters or less.

Notably, it has been discovered that such improved crystallization properties can be achieved without use of conventional nucleating agents, such as boron nucleating agents (e.g., boron nitride, boron sulfide, boron chloride, boric acid, boron carbide, boron oxide, zinc borate, etc.). While it is normally desired to minimize the presence of such conventional nucleating agents (e.g., boron compounds), they may nevertheless be present in a relatively small percentage in certain embodiments, such as in an amount of about 0.5 wt. % or less, in some embodiments about 0.1 wt. % or less, and in some embodiments, from about 0.001 wt. % to about 0.05 wt. % of the polymer composition.

While exhibiting a good crystallization properties, the polymer composition may nevertheless achieve a relative high degree of strength and rigidity. For example, the composition may exhibit a tensile break strain (“elongation”) of about 1.8% or more, in some embodiments from about 2% to about 5%, and in some embodiments, from about 2.2% to about 4% (as determined in accordance with ISO 527:2019 at a temperature of 23° C.). The composition may also exhibit a tensile modulus of about 16,000 MPa or more, in some embodiments from about 17,000 MPa to about 35,000 MPa, in some embodiments from about 18,000 MPa to about 30,000 MPa (as determined in accordance with ISO 527:2019 at a temperature of 23° C.) and/tensile stress at break (“tensile strength”) of about 100 MPa or more, in some embodiments from about 150 MPa to about 350 MPa, and in some embodiments, from about 180 to about 300 MPa (as determined in accordance with ISO 527:2019 at a temperature of 23° C.). The composition may also exhibit a flexural modulus of about 10,000 MPa or more, in some embodiments from about 12,000 MPa to about 32,000 MPa, in some embodiments from about 14,000 MPa to about 30,000 MPa and/or a flexural strength of about 100 MPa or more, in some embodiments from about 150 to about 500 MPa, and in some embodiments from about 225 to about 450 MPa (as determined in accordance with ISO 178:2019 at a temperature of 23° C.). The polymer composition may exhibit a high degree of impact strength, such as a Charpy notched impact strength of about 5 kJ/m² or more, such as in some embodiments from about 6 to about 30 kJ/m², and in some embodiments, from about 7 to about 20 kJ/m², as determined at a temperature of 23° C. in accordance with ISO 179-1:2010.

In addition, the polymer composition may exhibit good flow properties as reflected by a relatively low melt viscosity, such as about 5,000 poise or less, in some embodiments about 4,750 poise or less, and in some embodiments, from about 500 to about 4,500 poise, as determined in accordance with ISO 11443:2021 at a temperature of about 310° C. and at a shear rate of 1,200 s⁻¹. The polymer composition may also be thermally conductive. For example, the composition may exhibit an in-plane (or “in-flow”) thermal conductivity of about 2 W/m-K or more, in some embodiments about 0.1 W/m-K or more, in some embodiments about 0.15 to about 8 W/m-K, and in some embodiments, from about 0.2 to about 6 W/m-K, as determined in accordance with ASTM E 1461-13. Similarly, the polymer composition may exhibit a through-plane thermal conductivity of about 0.4 W/m-K or more, in some embodiments about 0.5 W/m-K or more, and in some embodiments, from about 0.6 to about 4 W/m-K, as determined in accordance with ASTM E 1461-13. Such high thermal conductivity values allow the composition to be capable of creating a thermal pathway for heat transfer away from an electrical component within which it is employed. In this manner, “hot spots” can be quickly eliminated and the overall temperature can be lowered during use. In addition, the surface resistivity of the polymer composition may be about 5×10¹⁶ ohms or less, in some embodiments about 1×10¹⁶ ohms or less, in some embodiments about 5×10¹⁵ ohms or less, and in some embodiments, from about 1×10¹³ to about 1×10¹⁵ ohms, such as determined at a temperature of about 20° C. in accordance with IEC 62631-3-2:2016.

Various embodiments of the present invention will now be described in greater detail below.

### I. Polymer Composition

### A. Polymer Matrix

The polymer matrix typically constitutes from about 40 wt. % to about 90 wt. %, in some embodiments from about 45 wt. % to about 85 wt. %, and in some embodiments, from about 50 wt. % to about 80 wt. % of the polymer composition. The polymer matrix contains at least one polyarylene sulfide. For example, polyarylene sulfides typically constitute from about 50 wt. % to 100 wt. %, in some embodiments from about 70 wt. % to 100 wt. %, and in some embodiments, from about 90 wt. % to 100 wt. % of the polymer matrix (e.g., 100 wt. %).

The polyarylene sulfide may be a homopolymers or copolymer. For instance, selective combination of dihaloaromatic compounds can result in a polyarylene sulfide copolymer containing not less than two different units. For instance, when p-dichlorobenzene is used in combination with m-dichlorobenzene or 4,4′-dichlorodiphenylsulfone, a polyarylene sulfide copolymer can be formed containing segments having the structure of formula:

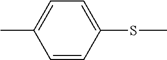

and segments having the structure of formula:

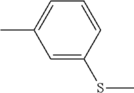

or segments having the structure of formula:

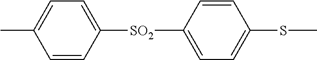

The polyarylene sulfide may be linear, semi-linear, branched, or crosslinked. Linear polyarylene sulfides typically contain 80 mol % or more of the repeating unit —(Ar—S)—. Such linear polymers may also include a small amount of a branching unit or a cross-linking unit, but the amount of branching or cross-linking units is typically less than about 1 mol % of the total monomer units of the polyarylene sulfide. A linear polyarylene sulfide polymer may be a random copolymer or a block copolymer containing the above-mentioned repeating unit. Semi-linear polyarylene sulfides may likewise have a cross-linking structure or a branched structure introduced into the polymer a small amount of one or more monomers having three or more reactive functional groups. By way of example, monomer components used in forming a semi-linear polyarylene sulfide can include an amount of polyhaloaromatic compounds having two or more halogen substituents per molecule which can be utilized in preparing branched polymers. Such monomers can be represented by the formula R′Xₙ, where each X is selected from chlorine, bromine, and iodine, n is an integer of 3 to 6, and R′ is a polyvalent aromatic radical of valence n which can have up to about 4 methyl substituents, the total number of carbon atoms in R′ being within the range of 6 to about 16. Examples of some polyhaloaromatic compounds having more than two halogens substituted per molecule that can be employed in forming a semi-linear polyarylene sulfide include 1,2,3-trichlorobenzene, 1,2,4-trichlorobenzene, 1,3-dichloro-5-bromobenzene, 1,2,4-triiodobenzene, 1,2,3,5-tetrabromobenzene, hexachlorobenzene, 1,3,5-trichloro-2,4,6-trimethylbenzene, 2,2′,4,4′-tetrachlorobiphenyl, 2,2′,5,5′-tetra-iodobiphenyl, 2,2′,6,6′-tetrabromo-3,3′,5,5′-tetramethylbiphenyl, 1,2,3,4-tetrachloronaphthalene, 1,2,4-tribromo-6-methylnaphthalene, etc., and mixtures thereof.

If desired, the polyarylene sulfide can be functionalized. For instance, a disulfide compound containing reactive functional groups (e.g., carboxyl, hydroxyl, amine, etc.) can be reacted with the polyarylene sulfide. Functionalization of the polyarylene sulfide can further provide sites for bonding between any impact modifiers and the polyarylene sulfide, which can improve distribution of the impact modifier throughout the polyarylene sulfide and prevent phase separation. The disulfide compound may undergo a chain scission reaction with the polyarylene sulfide during melt processing to lower its overall melt viscosity. When employed, disulfide compounds typically constitute from about 0.01 wt. % to about 3 wt. %, in some embodiments from about 0.02 wt. % to about 1 wt. %, and in some embodiments, from about 0.05 to about 0.5 wt. % of the polymer composition. The ratio of the amount of the polyarylene sulfide to the amount of the disulfide compound may likewise be from about 1000:1 to about 10:1, from about 500:1 to about 20:1, or from about 400:1 to about 30:1. Suitable disulfide compounds are typically those having the following formula:

R³—S—S—R⁴
wherein R³ and R⁴ may be the same or different and are hydrocarbon groups that independently include from 1 to about 20 carbons. For instance, R³ and R⁴ may be an alkyl, cycloalkyl, aryl, or heterocyclic group. In certain embodiments, R³ and R⁴ are generally nonreactive functionalities, such as phenyl, naphthyl, ethyl, methyl, propyl, etc. Examples of such compounds include diphenyl disulfide, naphthyl disulfide, dimethyl disulfide, diethyl disulfide, and dipropyl disulfide. R³ and R⁴ may also include reactive functionality at terminal end(s) of the disulfide compound. For example, at least one of R³ and R⁴ may include a terminal carboxyl group, hydroxyl group, a substituted or non-substituted amino group, a nitro group, or the like. Examples of compounds may include, without limitation, 2,2′-diaminodiphenyl disulfide, 3,3′-diaminodiphenyl disulfide, 4,4′-diaminodiphenyl disulfide, dibenzyl disulfide, dithiosalicyclic acid (or 2,2′-dithiobenzoic acid), dithioglycolic acid, α,α′-dithiodilactic acid, β,β′-dithiodilactic acid, 3,3′-dithiodipyridine, 4,4′dithiomorpholine, 2,2′-dithiobis(benzothiazole), 2,2′-dithiobis(benzimidazole), 2,2′-dithiobis(benzoxazole), 2-(4′-morpholinodithio)benzothiazole, etc., as well as mixtures thereof.

The melt flow rate of a polyarylene sulfide may be from about 100 to about 800 grams per 10 minutes (“g/10 min”), in some embodiments from about 200 to about 700 g/10 min, and in some embodiments, from about 300 to about 600 g/10 min, as determined in accordance with ISO 1133-1:2022 at a load of 5 kg and temperature of 316° C.

The polyarylene sulfides, such as described above, typically have a DTUL value of from about 70° C. to about 220° C., in some embodiments from about 90° C. to about 200° C., and in some embodiments, from about 120° C. to about 180° C. as determined in accordance with ISO 75-2:2013 at a load of 1.8 MPa. The polyarylene sulfides likewise typically have a glass transition temperature of from about 50° C. to about 120° C., in some embodiments from about 60° C. to about 115° C., and in some embodiments, from about 70° C. to about 110° C., as well as a melting temperature of from about 220° C. to about 340° C., in some embodiments from about 240° C. to about 320° C., and in some embodiments, from about 260° C. to about 300° C.

### B. Inorganic Fibers

As indicated above, inorganic fibers are also employed in the polymer composition that can simultaneously improve the crystallization rate of the composition, as well as its thermal and mechanical properties. The inorganic fibers typically have a high degree of tensile strength relative to their mass. For example, the ultimate tensile strength of the fibers (determined in accordance with ASTM D822/D822M-13 (2018)) is typically from about 1,000 to about 15,000 Megapascals (“MPa”), in some embodiments from about 2,000 MPa to about 10,000 MPa, and in some embodiments, from about 3,000 MPa to about 6,000 MPa. Further, although the fibers may have a variety of different sizes, fibers having a certain size can help improve the mechanical properties of the resulting polymer composition. The inorganic fibers may, for example, have a nominal diameter of from about 5 micrometers to about 40 micrometers, in some embodiments from about 6 micrometers to about 30 micrometers, in some embodiments from about 8 micrometers to about 20 micrometers, and in some embodiments from about 9 micrometers to about 15 micrometers. The fibers (after compounding) may also have a relatively high aspect ratio (average length (μm) divided by nominal diameter (μm)), such as about 2 or more, in some embodiments from about 4 to about 100, in some embodiments from about 5 to about 50, and in some embodiments, from about 8 to about 40 are particularly beneficial. Such fibers may, for instance, have a volume average length (after compounding) of about 10 micrometers or more, in some embodiments about 25 micrometers or more, in some embodiments from about 50 micrometers or more to about 800 micrometers or less, and in some embodiments from about 60 micrometers to about 500 micrometers. The relative amount of the fibers may also be selectively controlled to help achieve the desired crystallization rate without adversely impacting other properties of the composition, such as its flowability and mechanical properties. The inorganic fibers may, for instance, constitute from about 30 to about 120 parts by weight, in some embodiments from about 40 to about 110 parts by weight, and in some embodiments, from about 50 to about 100 parts by weight per 100 parts by weight of the polymer matrix. For example, the inorganic fibers may constitute from about 20 wt. % to about 60 wt. %, in some embodiments from about 25 wt. % to about 55 wt. %, and in some embodiments, from about 30 wt. % to about 50 wt. % of the polymer composition.

In addition to the size, strength, and relative concentration, the composition of the inorganic fibers may also be selectively controlled to achieve better crystallization rates. Generally speaking, the inorganic fibers may be formed from materials that are generally insulative in nature, such as glass, ceramics (e.g., alumina or silica), etc. Glass fibers are particularly suitable, such as E-glass, E-CR glass, A-glass, C-glass, D-glass, AR-glass, R-glass, S1-glass, S2-glass, etc., as well as mixtures of any of the foregoing. Glass fibers that are generally free of boron (e.g., E-CR glass fibers) are particularly suitable. In certain embodiments, the glass fibers may include silica (SiO₂), alumina (Al₂O₃), and oxides of calcium and magnesium (e.g., CaO, MgO, etc.), but are generally free of boron and optionally fluorides. For example, the glass fibers may contain boron in a concentration of about 1 wt. % or less, in some embodiments about 0.5 wt. % or less, in some embodiment about 0.1 wt. % or less (e.g., 0 wt. %), relative to the total weight of the glass fibers. The glass fibers may likewise contain fluorides in a concentration of about 0.5 wt. % or less, in some embodiments about 0.2 wt. % or less, in some embodiment about 0.01 wt. % or less (e.g., 0 wt. %), relative to the total weight of the glass fibers. Boron concentration and fluoride concentration can be measured by inductively coupled plasma-atomic emission spectrometry. In the absence of boric oxide, the glass fibers may further include titanium dioxide (TiO₂) to reduce melt viscosity. For example, the concentration of titanium in the glass fibers may be about 0.1 wt. % to about 1 wt. %, and in some embodiments, from about 0.15 wt. % to about 0.5 wt. % of the total weight of the glass fibers. Besides titanium dioxide, the glass fibers can further include potassium oxide (K₂O) and/or lithium oxide (Li₂O) as fluxing agents. For example, the concentration of potassium in the glass fibers may be about 0.2 wt. % to about 1 wt. %, and in some embodiments, from about 0.3 wt. % to about 0.5 wt. % of the total weight of the glass fibers. The concentration of lithium in the glass fibers may also be about 0.1 wt. % to about 1 wt. %, and in some embodiments, from about 0.2 wt. % to about 0.5 wt. % of the total weight of the glass fibers. The glass fibers may also have a relatively low amount of sodium oxide (Na₂O). For example, the concentration of sodium in the glass fibers may be about 0.1 wt. % to about 1 wt. %, and in some embodiments, from about 0.2 wt. % to about 0.5 wt. % of the total weight of the glass fibers. Titanium, potassium, lithium, and sodium concentrations can be measured by ICP-AES. In one particular embodiment, the glass fibers may contain silica in an amount of from about 57.5 wt. % to about 59.5 wt. %, alumina in an amount of from about 17 wt. % to about 20 wt. %, calcium oxide in an amount of from about 11 wt. % to about 13.5 wt. %, magnesium oxide in an amount of from about 8.5 wt. % to about 12.5 wt. %, and optionally sodium oxide, potassium oxide, lithium oxide, and/or titanium oxide. Other oxides may also be employed, such as iron oxide (Fe₂O₃).

If desired, the inorganic fibers may contain a sizing composition coated thereon to help improve the crystallization rate. The sizing composition may include an organosilane compound that is capable of forming Si—O—Si covalent bonds between the glass fiber surface and silanols obtained by hydrolysis of the silane compound, as well as between adjacent silanol groups. The resulting covalent bonds forms a crosslinked structure at the surface of the fibers that can enhance resistance to hydrolysis. Such organosilane compounds may, for instance, constitute from about 2 wt. % to about 40 wt. %, in some embodiments from about 2.5 wt. % to about 20 wt. %, and in some embodiments, from about 5 wt. to about 15 wt. % of the solids content of the sizing composition (i.e., excluding water). The organosilane compound may, for example, be any alkoxysilane as is known in the art, such as vinlyalkoxysilanes, epoxyalkoxysilanes, aminoalkoxysilanes, mercaptoalkoxysilanes, and combinations thereof. In one embodiment, for instance, the organosilane compound may have the following general formula:

R⁵—Si—(R⁶)₃,
wherein,
R⁵ is a sulfide group (e.g., —SH), an alkyl sulfide containing from 1 to 10 carbon atoms (e.g., mercaptopropyl, mercaptoethyl, mercaptobutyl, etc.), alkenyl sulfide containing from 2 to 10 carbon atoms, alkynyl sulfide containing from 2 to 10 carbon atoms, amino group (e.g., NH₂), aminoalkyl containing from 1 to 10 carbon atoms (e.g., aminomethyl, aminoethyl, aminopropyl, aminobutyl, etc.); aminoalkenyl containing from 2 to 10 carbon atoms, aminoalkynyl containing from 2 to 10 carbon atoms, and so forth;
R⁶ is an alkoxy group of from 1 to 10 carbon atoms, such as methoxy, ethoxy, propoxy, and so forth.

Aminosilane compounds are particularly suitable and may include monomeric or oligomeric (<6 units) silanes. Aminotrialkoxysilanes may be employed in certain embodiments to form a three dimensional network of Si—O—Si covalent bonds at the surface and around the surface of the fibers. Aminodialkoxysilanes may likewise be employed in certain embodiments to form a hairlike structure on the surface of the fibers. While not necessarily forming a three-dimensional crosslinked protective sheath around the fibers, the dialkoxysilanes may nevertheless facilitate impregnation of the fiber bundles and wetting of the individual fibers by a polymer melt, as well as reduce the hydrophilicity of the surface of the fibers believed to contribute to resistance to hydrolysis. Thus, it may be desirable to employ trialkoxysilanes, dialkoxysilanes, or mixtures thereof in the sizing composition. Specific examples of suitable aminosilanes may include, for instance, aminodialkoxysilanes, such as γ-aminopropylmethyldiethoxysilane, N-β-(Aminoethyl)-gamma-aminopropylmethyldimethoxysilane, N-β-(Aminoethyl)-γ-aminopropyl-methyldimethoxysilane, N-β-(Aminoethyl)-γ-aminoisobutylmethyldimethoxy-silane, γ-aminopropylmethyldimethoxysilane, N-β-(Aminoethyl)-γ-aminopropyl-methyldiethoxysilane, etc.; aminotrialkoxysilanes, such as γ-aminopropyltriethoxysilane, γ-aminopropyltri-methoxysilane, N-β-(Aminoethyl)-γ-aminopropyl-trimethoxysilane, N-β-(Aminoethyl)-γ-aminopropyltriethoxysilane, diethylene-triaminopropyltrimethoxysilane, Bis-(γ-trimethoxysilylpropyl) amine, N-phenyl-γ-aminopropyltrimethoxysilane, γ-amino-3,3-dimethylbutyltrimethoxysilane, γ-aminobutyltriethoxysilane, etc.; as well as mixtures of any of the foregoing.

In addition to an organosilane compound, the sizing composition may also contain one or more functionalized compounds that may be crosslinked to form a three-dimensional polymer network. Without intending to be limited by theory, it is believe that this may further enhance the ability of the fiber to improve the crystallization rate of the composition. When employed, such functionalized compounds may constitute from about 5 wt. % to about 90 wt. %, in some embodiments from about 10 wt. % to about 80 wt. %, and in some embodiments, from about 15 wt. to about 70 wt. % of the solids content of the sizing composition (i.e., excluding water). In one embodiment, for instance, the functionalized compound may be a blocked isocyanate. As used herein, the term “blocked isocyanate” refers to an isocyanate in which one or more of the isocyanate groups of an organic polyisocyanate have been reversibly reacted with a blocking agent. In this manner, the resulting blocked (partially or fully) isocyanate groups are stable to active hydrogens at ambient temperature but can become deblocked at elevated temperatures so that they are reactive with active hydrogens, such as, for example, at temperatures between about 90° C. to about 210° C., in some embodiments between about 105° C. to about 180° C., and in some embodiments, between about 125° C. to about 170° C. Representative examples of suitable organic polyisocyanates include aliphatic isocyanates (e.g., trimethylene diisocyanate, tetramethylene diisocyanate, hexamethylene diisocyanate, butylidene diisocyanate, etc.); (cyclo)aliphatic isocyanates (e.g., isophorone diisocyanate (IPDI), 4,4′-diisocyanato-dicyclohexylmethane (HMDI), etc.); aromatic isocyanates (e.g., p-phenylene diisocyanate); aliphatic-aromatic isocyanates (e.g., 4,4′-diphenylene methane diisocyanate, 2,4- or 2,6-tolylene diisocyanate, etc.); as well as mixtures thereof. Representative examples of suitable blocking agents include, but are not limited to, oximes, such as methyl ethyl ketoxime, acetone oxime and cyclohexanone oxime; lactams, such as epsilon-caprolactam; alcohols; malonic esters; alkyl acetoacetates, triazoles; pyrazoles; phenols; amines, such as benzyl t-butylamine; as well as mixtures thereof. In one embodiment, the blocked isocyanate is a blocked cycloaliphatic polyisocyanate.

The functionalized compound may also include polymers that contain an anhydride and/or carboxylic functionality. Examples of such polymers may include, for instance, a copolymer of ethylene-maleic anhydride, butadiene-maleic anhydride, isobutylene-maleic anhydride acrylate-maleic anhydride, polyacrylic acid, etc. When employed, such anhydride- and/or carboxylic-functionalized polymers may constitute from about 5 wt. % to about 60 wt. %, in some embodiments from about 10 wt. % to about 40 wt. %, and in some embodiments, from about 15 wt. to about 30 wt. % of the solids content of the sizing composition (i.e., excluding water). Other functionalized polymers may also be employed, either alone or in combination with polymers that contain an anhydride and/or carboxylic functionality. In certain embodiments, for example, an epoxy-functionalized polymer may be employed, such as epoxy phenol novolac (EPN), epoxy cresol novolac (ECN), etc. When employed, such epoxy-functionalized polymers may constitute from about 30 wt. % to about 90 wt. %, in some embodiments from about 40 wt. % to about 80 wt. %, and in some embodiments, from about 50 wt. to about 70 wt. % of the solids content of the sizing composition (i.e., excluding water). In certain embodiments, combinations of such functionalized polymers may also be employed. In fact, it is believed that a dense crosslinked sheath can formed around the inorganic fibers by reaction of epoxy groups with maleic anhydride and/or carboxylic groups.

Apart from organosilane and functionalized compounds, the sizing composition may also contain a film-forming agent that can help protect the fibers from damage during processing and promote compatibility of the fibers with the polymer matrix. Particularly suitable film forming agents are polymers, such as polyurethanes, (meth)acrylate polymers, epoxy resin emulsions (e.g., based on epoxy bisphenol A or epoxy bisphenol F), epoxy ester resins, epoxy urethane resins, polyamides, etc., as well as mixtures of any of the foregoing. In one particular embodiment, for example, the film forming agent may include a polymer that is also functionalized, such as a polymer that includes a blocked isocyanate functionality as described above. Examples of such functionalized film-forming agents may include polyester-based and polyether-based polyurethanes that include a blocked isocyanate. When employed, such film forming agents may constitute from about 0.1 wt. % to about 50 wt. %, in some embodiments from about 1 wt. % to about 40 wt. %, and in some embodiments, from about 5 wt. to about 30 wt. % of the solids content of the sizing composition (i.e., excluding water). Other additives may also be employed in the sizing composition, such as pH adjusters, lubricants, antistatic agents, antifoaming agents, crosslinking agents, etc.

The sizing composition may be applied to the surface of the inorganic fibers in a variety of different ways. For example, the sizing composition may be applied as the fibers are formed out of a bushing. The entire composition may also be applied to the fibers in a single step, or one or more components of the sizing composition may be applied separately. In one embodiment, for example, a two-stage application process may be employed in which a polymer containing an anhydride and/or carboxylic acid functionality is applied in a first stage and a polymer containing an epoxy functionality is applied in a second stage. In this manner, the polymers may be crosslinked together only after application to the fiber surface. Other components of the sizing composition may be applied separately or in combination with one or both of the polymers. Notwithstanding the particular process employed, one or more solvents (e.g., water) may be added to the components of the sizing composition during application to aid in the coating process. Once coated, the fibers may be dried to remove the solvent. In this regard, the moisture content of the coated fibers is typically about 0.5 wt. % or less, in some embodiments about 0.2 wt. % or less, and in some embodiments about 0.1 wt. % or less. Likewise, the amount of the sizing composition employed is typically from about 0.3 wt. % to about 1.2 wt. %, in some embodiments from about 0.4 wt. % to about 1 wt. %, and in some embodiments, from about 0.5 wt. % to about 0.8 wt. % based on the total weight of the coated fibers.

### C. Optional Components

In addition to the components noted above, the polymer composition may also contain a variety of other optional components to help improve its overall properties. If desired, for example, an organosilane compound may also be employed in the polymer composition, such as in an amount of from about 0.1 to about 8 parts, in some embodiments from about 0.3 to about 5 parts, and in some embodiments, from about 0.5 to about 3 parts by weight per 100 parts by weight of the polymer matrix. For example, organosilane compounds can constitute from about 0.01 wt. % to about 3 wt. %, in some embodiments from about 0.05 wt. % to about 2 wt. %, and in some embodiments, from about 0.1 to about 1 wt. % of the polymer composition. The organosilane compound may, for example, be any alkoxysilane as is known in the art, such as vinlyalkoxysilanes, epoxyalkoxysilanes, aminoalkoxysilanes, mercaptoalkoxysilanes, and combinations thereof. In one embodiment, for instance, the organosilane compound may have the following general formula:

R⁵—Si—(R⁶)₃,
wherein,
R⁵ is a sulfide group (e.g., —SH), an alkyl sulfide containing from 1 to 10 carbon atoms (e.g., mercaptopropyl, mercaptoethyl, mercaptobutyl, etc.), alkenyl sulfide containing from 2 to 10 carbon atoms, alkynyl sulfide containing from 2 to 10 carbon atoms, amino group (e.g., NH₂), aminoalkyl containing from 1 to 10 carbon atoms (e.g., aminomethyl, aminoethyl, aminopropyl, aminobutyl, etc.); aminoalkenyl containing from 2 to 10 carbon atoms, aminoalkynyl containing from 2 to 10 carbon atoms, and so forth; and
R⁶ is an alkoxy group of from 1 to 10 carbon atoms, such as methoxy, ethoxy, propoxy, and so forth.

Some representative examples of organosilane compounds that may be included in the mixture include mercaptopropyl trimethyoxysilane, mercaptopropyl triethoxysilane, aminopropyl triethoxysilane, aminoethyl triethoxysilane, aminopropyl trimethoxysilane, aminoethyl trimethoxysilane, ethylene trimethoxysilane, ethylene triethoxysilane, ethyne trimethoxysilane, ethyne triethoxysilane, aminoethylaminopropyltrimethoxysilane, 3-aminopropyl triethoxysilane, 3-aminopropyl trimethoxysilane, 3-aminopropyl methyl dimethoxysilane or 3-aminopropyl methyl diethoxysilane, N-(2-aminoethyl)-3-aminopropyl trimethoxysilane, N-methyl-3-aminopropyl trimethoxysilane, N-phenyl-3-aminopropyl trimethoxysilane, bis(3-aminopropyl) tetramethoxysilane, bis(3-aminopropyl) tetraethoxy disiloxane, γ-aminopropyltrimethoxysilane, γ-aminopropyltriethoxysilane, γ-aminopropylmethyldimethoxysilane, γ-aminopropylmethyldiethoxysilane, N-(p-aminoethyl)-γ-aminopropyltrimethoxysilane, N-phenyl-γ-aminopropyltrimethoxysilane, γ-diallylaminopropyltrimethoxysilane, γ-diallylaminopropyltrimethoxysilane, etc., as well as combinations thereof. Particularly suitable organosilane compounds are 3-aminopropyltriethoxysilane and 3-mercaptopropyltrimethoxysilane.

An impact modifier may also be employed within the polymer composition. When employed, the impact modifier(s) typically constitute from about 1 to about 30 parts, in some embodiments from about 2 to about 20 parts, and in some embodiments, from about 5 to about 15 parts by weight per 100 parts by weight of the polyarylene sulfide(s). For example, the impact modifiers may constitute from about 0.1 wt. % to about 20 wt. %, in some embodiments from about 0.5 wt. % to about 15 wt. %, and in some embodiments, from about 1 wt. % to about 10 wt. % of the polymer composition.

Examples of suitable impact modifiers may include, for instance, polyepoxides, polyurethanes, polybutadiene, acrylonitrile-butadiene-styrene, polyamides, block copolymers (e.g., polyether-polyamide block copolymers), etc., as well as mixtures thereof. In one embodiment, an olefin copolymer is employed that is “epoxy-functionalized” in that it contains, on average, two or more epoxy functional groups per molecule. The copolymer generally contains an olefinic monomeric unit that is derived from one or more α-olefins. Examples of such monomers include, for instance, linear and/or branched α-olefins having from 2 to 20 carbon atoms and typically from 2 to 8 carbon atoms. Specific examples include ethylene, propylene, 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired α-olefin monomers are ethylene and propylene. The copolymer may also contain an epoxy-functional monomeric unit. One example of such a unit is an epoxy-functional (meth)acrylic monomeric component. As used herein, the term “(meth)acrylic” includes acrylic and methacrylic monomers, as well as salts or esters thereof, such as acrylate and methacrylate monomers. For example, suitable epoxy-functional (meth)acrylic monomers may include, but are not limited to, those containing 1,2-epoxy groups, such as glycidyl acrylate and glycidyl methacrylate. Other suitable epoxy-functional monomers include allyl glycidyl ether, glycidyl ethacrylate, and glycidyl itoconate. Other suitable monomers may also be employed to help achieve the desired molecular weight.

Of course, the copolymer may also contain other monomeric units as is known in the art. For example, another suitable monomer may include a (meth)acrylic monomer that is not epoxy-functional. Examples of such (meth)acrylic monomers may include methyl acrylate, ethyl acrylate, n-propyl acrylate, i-propyl acrylate, n-butyl acrylate, s-butyl acrylate, i-butyl acrylate, t-butyl acrylate, n-amyl acrylate, i-amyl acrylate, isobornyl acrylate, n-hexyl acrylate, 2-ethylbutyl acrylate, 2-ethylhexyl acrylate, n-octyl acrylate, n-decyl acrylate, methylcyclohexyl acrylate, cyclopentyl acrylate, cyclohexyl acrylate, methyl methacrylate, ethyl methacrylate, 2-hydroxyethyl methacrylate, n-propyl methacrylate, n-butyl methacrylate, i-propyl methacrylate, i-butyl methacrylate, n-amyl methacrylate, n-hexyl methacrylate, i-amyl methacrylate, s-butyl-methacrylate, t-butyl methacrylate, 2-ethylbutyl methacrylate, methylcyclohexyl methacrylate, cinnamyl methacrylate, crotyl methacrylate, cyclohexyl methacrylate, cyclopentyl methacrylate, 2-ethoxyethyl methacrylate, isobornyl methacrylate, etc., as well as combinations thereof. In one particular embodiment, for example, the copolymer may be a terpolymer formed from an epoxy-functional (meth)acrylic monomeric component, α-olefin monomeric component, and non-epoxy functional (meth)acrylic monomeric component. The copolymer may, for instance, be poly(ethylene-co-butylacrylate-co-glycidyl methacrylate).

The relative portion of the monomeric component(s) may be selected to achieve a balance between epoxy-reactivity and melt flow rate. More particularly, high epoxy monomer contents can result in good reactivity with the polyarylene sulfide, but too high of a content may reduce the melt flow rate to such an extent that the copolymer adversely impacts the melt strength of the polymer blend. Thus, in most embodiments, the epoxy-functional (meth)acrylic monomer(s) constitute from about 1 wt. % to about 20 wt. %, in some embodiments from about 2 wt. % to about 15 wt. %, and in some embodiments, from about 3 wt. % to about 10 wt. % of the copolymer. The α-olefin monomer(s) may likewise constitute from about 55 wt. % to about 95 wt. %, in some embodiments from about 60 wt. % to about 90 wt. %, and in some embodiments, from about 65 wt. % to about 85 wt. % of the copolymer. When employed, other monomeric components (e.g., non-epoxy functional (meth)acrylic monomers) may constitute from about 5 wt. % to about 35 wt. %, in some embodiments from about 8 wt. % to about 30 wt. %, and in some embodiments, from about 10 wt. % to about 25 wt. % of the copolymer. The resulting melt flow rate is typically from about 1 to about 30 grams per 10 minutes (“g/10 min”), in some embodiments from about 2 to about 20 g/10 min, and in some embodiments, from about 3 to about 15 g/10 min, as determined in accordance with ASTM D1238-13 at a load of 2.16 kg and temperature of 190° C.

Still other components that can be included in the composition may include, for instance, particulate fillers (e.g., talc, mica, etc.), pigments (e.g., black pigments), antioxidants, stabilizers (e.g., heat stabilizers, UV stabilizers, etc.), surfactants, waxes, flow promoters, lubricants, and other materials added to enhance properties and processability.

### II. Melt Processing

The manner in which the polyarylene sulfide(s), inorganic fibers, and various other optional additives are combined may vary as is known in the art. For instance, the materials may be supplied either simultaneously or in sequence to a melt processing device that dispersively blends the materials. Batch and/or continuous melt processing techniques may be employed. For example, a mixer/kneader, Banbury mixer, Farrel continuous mixer, single-screw extruder, twin-screw extruder, roll mill, etc., may be utilized to blend and melt process the materials. One particularly suitable melt processing device is a co-rotating, twin-screw extruder (e.g., Leistritz co-rotating fully intermeshing twin screw extruder). Such extruders may include feeding and venting ports and provide high intensity distributive and dispersive mixing. For example, the components may be fed to the same or different feeding ports of a twin-screw extruder and melt blended to form a substantially homogeneous melted mixture. Melt blending may occur under high shear/pressure and heat to ensure sufficient dispersion. For example, melt processing may occur at a temperature of from about 100° C. to about 500° C., and in some embodiments, from about 150° C. to about 300° C. Likewise, the apparent shear rate during melt processing may range from about 100 seconds⁻¹ to about 10,000 seconds⁻¹, and in some embodiments, from about 500 seconds⁻¹ to about 1,500 seconds⁻¹. Of course, other variables, such as the residence time during melt processing, which is inversely proportional to throughput rate, may also be controlled to achieve the desired degree of homogeneity.

If desired, one or more distributive and/or dispersive mixing elements may be employed within the mixing section of the melt processing unit. Suitable distributive mixers may include, for instance, Saxon, Dulmage, Cavity Transfer mixers, etc. Likewise, suitable dispersive mixers may include Blister ring, Leroy/Maddock, CRD mixers, etc. As is well known in the art, the mixing may be further increased in aggressiveness by using pins in the barrel that create a folding and reorientation of the polymer melt, such as those used in Buss Kneader extruders, Cavity Transfer mixers, and Vortex Intermeshing Pin mixers. The speed of the screw can also be controlled to improve the characteristics of the composition. For instance, the screw speed can be about 400 rpm or less, in one embodiment, such as between about 200 rpm and about 350 rpm, or between about 225 rpm and about 325 rpm. In one embodiment, the compounding conditions can be balanced so as to provide a polymer composition that exhibits improved properties. For example, the compounding conditions can include a screw design to provide mild, medium, or aggressive screw conditions. For example, system can have a mildly aggressive screw design in which the screw has one single melting section on the downstream half of the screw aimed towards gentle melting and distributive melt homogenization. A medium aggressive screw design can have a stronger melting section upstream from the filler feed barrel focused more on stronger dispersive elements to achieve uniform melting. Additionally, it can have another gentle mixing section downstream to mix the fillers. This section, although weaker, can still add to the shear intensity of the screw to make it stronger overall than the mildly aggressive design. A highly aggressive screw design can have the strongest shear intensity of the three. The main melting section can be composed of a long array of highly dispersive kneading blocks. The downstream mixing section can utilize a mix of distributive and intensive dispersive elements to achieve uniform dispersion of all type of fillers. The shear intensity of the highly aggressive screw design can be significantly higher than the other two designs. In one embodiment, a system can include a medium to aggressive screw design with relatively mild screw speeds (e.g., between about 200 rpm and about 300 rpm).

### III. Molded Part

A molded part may be formed from the polymer composition using a variety of different techniques. Suitable techniques may include, for instance, injection molding, low-pressure injection molding, extrusion compression molding, gas injection molding, foam injection molding, low-pressure gas injection molding, low-pressure foam injection molding, gas extrusion compression molding, foam extrusion compression molding, extrusion molding, foam extrusion molding, compression molding, foam compression molding, gas compression molding, etc. For example, an injection molding system may be employed that includes a mold within which the polymer composition may be injected. The time inside the injector may be controlled and optimized so that polymer matrix is not pre-solidified. When the cycle time is reached and the barrel is full for discharge, a piston may be used to inject the composition to the mold cavity. Compression molding systems may also be employed. As with injection molding, the shaping of the polymer composition into the desired article also occurs within a mold. The composition may be placed into the compression mold using any known technique, such as by being picked up by an automated robot arm. The temperature of the mold may be maintained at or above the solidification temperature of the polymer composition for a desired time period to allow for solidification. The molded product may then be solidified by bringing it to a temperature below that of the melting temperature. The resulting product may be de-molded. The cycle time for each molding process may be adjusted to suit the polymer composition, to achieve sufficient bonding, and to enhance overall process productivity.

The polymer composition is particularly well suited for use in injection molded parts having a small dimensional tolerance. For example, as is known in the art, injection can occur in two main phases—i.e., an injection phase and holding phase. During the injection phase, the mold cavity is completely filled with the molten polymer composition. The holding phase is initiated after completion of the injection phase in which the holding pressure is controlled to pack additional material into the cavity and compensate for volumetric shrinkage that occurs during cooling. After the shot has built, it can then be cooled. Once cooling is complete, the molding cycle is completed when the mold opens and the part is ejected, such as with the assistance of ejector pins within the mold.

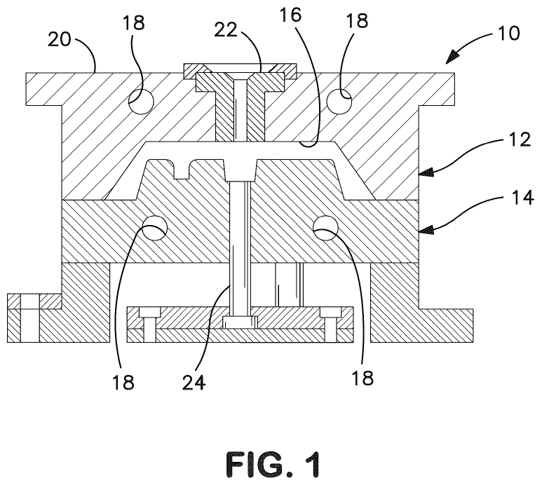

Any suitable injection molding equipment may generally be employed. Referring to FIG. 1, for example, one embodiment of an injection molding apparatus or tool 10 that may be employed is shown. In this embodiment, the apparatus 10 includes a first mold base 12 and a second mold base 14, which together define an article or component-defining mold cavity 16. The molding apparatus 10 also includes a resin flow path that extends from an outer exterior surface 20 of the first mold half 12 through a sprue 22 to a mold cavity 16. The resin flow path may also include a runner and a gate, both of which are not shown for purposes of simplicity. The polymer composition may be supplied to the resin flow path using a variety of techniques. For example, the polymer composition may be supplied (e.g., in the form of pellets) to a feed hopper attached to an extruder barrel that contains a rotating screw (not shown). As the screw rotates, the pellets are moved forward and undergo pressure and friction, which generates heat to melt the pellets. Additional heat may also be supplied to the composition by a heating medium that is communication with the extruder barrel. One or more ejector pins 24 may also be employed that are slidably secured within the second mold half 14 to define the mold cavity 16 in the closed position of the apparatus 10. The ejector pins 24 operate in a well-known fashion to remove a molded part from the cavity 16 in the open position of the molding apparatus 10.

A cooling mechanism may also be provided to solidify the resin within the mold cavity. In FIG. 1, for instance, the mold bases 12 and 14 each include one or more cooling lines 18 through which a cooling medium flows to impart the desired mold temperature to the surface of the mold bases for solidifying the molten material. Due to the unique crystallization properties of the polymer composition, the “cooling time” during a molding cycle can be substantially reduced while still achieving the same degree of crystallization. The cooling time can be represented by the “normalized cooling ratio”, which is determined by dividing the total cooling time by the average thickness of the molded part. As a result of the present invention, for example, the normalized cooling ratio may range from about 0.2 to about 8 seconds per millimeter, in some embodiments from about 0.5 to about 6 seconds per millimeter, and in some embodiments, from about 1 to about 5 seconds per millimeter. The total cooling time can be determined from the point when the composition is injected into the mold cavity to the point that it reaches an ejection temperature at which it can be safely ejected. Exemplary cooling times may range, for instance, from about 1 to about 60 seconds, in some embodiments from about 5 to about 40 seconds, and in some embodiments, from about 10 to about 35 seconds.

In addition to minimizing the required cooling time for a molding cycle, the method and composition of the present invention can also allow parts to be molded at lower temperatures while still achieving the same degree of crystallization. For example, the mold temperature (e.g., temperature of a surface of the mold) may be from about 50° C. to about 120° C., in some embodiments from about 60° C. to about 110° C., and in some embodiments, from about 70° C. to about 90° C. In addition to minimizing the energy requirements for the molding operation, such low mold temperatures may be accomplished using cooling mediums that are less corrosive and expensive than some conventional techniques. For example, liquid water may be employed as a cooling medium.

Regardless of the molding technique employed, the polymer composition may be molded into a part for use in any application, such as in an electric vehicle, fuel cell or alkaline electrolyzer system, battery assembly, electronic component, etc. Examples of electronic components may, for instance, include cellular telephones, laptop computers, small portable computers (e.g., ultraportable computers, netbook computers, and tablet computers), wrist-watch devices, pendant devices, headphone and earpiece devices, media players with wireless communications capabilities, handheld computers (also sometimes called personal digital assistants), remote controllers, global positioning system (GPS) devices, handheld gaming devices, battery covers, speakers, camera modules, integrated circuits (e.g., SIM cards), etc.

In one particular embodiment, the polymer composition described herein can be included in various components of an electric vehicle, such as in battery systems (e.g., busbar, housings, etc.), electrical systems (e.g., inverter modules), interconnection systems (e.g., connectors, EMI core, etc.), thermal management systems, and so forth. A thermal management system of an electric vehicle, for example, can generally include multiple different subsystems such as, without limitation, a power train subsystem, a refrigeration subsystem, a battery cooling subsystem, and a heating, ventilation, and cooling (HVAC) subsystem. In some embodiments, one or more subsystems of a thermal management system may in fluid communication with one another, thus allowing hot heat transfer medium to flow from the high temperature circuit into the low temperature circuit, and cooler heat transfer medium to flow from the low temperature circuit into the high temperature circuit. By way of example, a first temperature control loop in a typical electric vehicle can include a heat transfer medium (e.g., water, coolant, or a mixtures thereof) that is pumped through the loop via a suitable pump, e.g., an electric pump, and cooled via heat transfer with a refrigerant in a heat exchanger (e.g., an energy storage system (ESS) heat exchanger) as well as a radiator/reservoir. Additionally, the loop can include a heater (e.g., a positive temperature coefficient (PTC) heater), which can ensure that the temperature of the system can be maintained within its preferred operating range regardless of the ambient temperature, and the battery assembly. A second temperature control loop can also include a heat transfer medium that can be the same or differ from the heat transfer medium of another subsystem. The heat transfer medium of the second temperature control loop can be pumped through the loop with a suitable pump, a heat exchanger, and a radiator reservoir. A high temperature control loop can be utilized in cooling the power electronics as well as the electric machines of the vehicle. In one particular embodiment, the polymer composition may be used in an electric coolant pump, which may include an electric motor as a drive source and a hydraulic portion for generating coolant suction and discharge forces. The motor and associated components are retained with in the motor housing. Various components of the electric pump, such as housings, casings, interfaces, etc., may incorporate the polymer composition of the invention.

The present invention may be better understood with reference to the following examples.

### Test Methods

Melt Viscosity: The melt viscosity (Pa-s) may be determined in accordance with ISO 11443:2021 at a shear rate of 400 s⁻¹ and using a Dynisco LCR7001 capillary rheometer. The rheometer orifice (die) may have a diameter of 1 mm, length of 20 mm, L/D ratio of 20.1, and an entrance angle of 180°. The diameter of the barrel may be 9.55 mm+0.005 mm and the length of the rod was 233.4 mm. The melt viscosity is typically determined at a temperature of 310° C.

Tensile Modulus, Tensile Stress at Break, and Tensile strain at Break: Tensile properties may be tested according to ISO 527-2/1A:2019 (technically equivalent to ASTM D638-14). Modulus and strength measurements may be made on the same test strip sample having a length of 80 mm, thickness of 10 mm, and width of 4 mm. The testing temperature may be 23° C., and the testing speeds may be 5 mm/min.

Flexural Modulus and Flexural Stress: Flexural properties may be tested according to ISO 178:2019 (technically equivalent to ASTM D790-10). This test may be performed on a 64 mm support span. Tests may be run on the center portions of uncut ISO 3167 multi-purpose bars. The testing temperature may be 23° C. and the testing speed may be 2 mm/min.

Charpy Impact Strength: Charpy properties may be tested according to ISO ISO 179-1:2010) (technically equivalent to ASTM D256-10, Method B). This test may be run using a Type 1 specimen size (length of 80 mm, width of 10 mm, and thickness of 4 mm). The testing may be conducted with or without a notch. When testing the notched impact strength, the notch may be a Type A notch (0.25 mm base radius). Specimens may be cut from the center of a multi-purpose bar using a single tooth milling machine. The testing temperature may be 23° C. or −30° C.

Surface Resistivity: The surface resistivity values are generally determined in accordance with IEC 62631-3-2-2016 (equivalent to ASTM D257-14). According to this procedure, a standard specimen (e.g., 1 meter cube) is placed between two electrodes. A voltage is applied for sixty (60) seconds and the resistance is measured. The surface resistivity is the quotient of the potential gradient (in V/m) and the current per unit of electrode length (in A/m), and generally represents the resistance to leakage current along the surface of an insulating material. Because the four (4) ends of the electrodes define a square, the lengths in the quotient cancel and surface resistivities are reported in ohms, although it is also common to see the more descriptive unit of ohms per square.

### Comparative Examples 1-6

Comparative Examples 1-2 were melt mixed using a 32 mm Coperion co-rotating, fully-intermeshing, twin-screw extruder and include various concentrations of a polyarylene sulfide (PPS-1, PPS-2, and PPS-3), glass fibers, silane coupling agent, nucleating agent, black pigment masterbatch, and lubricant (Glycolube). PPS-1 had a melt viscosity of about 5.5 kPoise, and PPS-2 and PPS-3 each have a melt flow rate of about 500 g/10 min (31600, 5 kg). The glass fibers were F-glass fibers having a fiber diameter of 10 micrometers.

| | Comp. | Comp. | Comp. | Comp. | Comp. | Comp. |
|---|---|---|---|---|---|---|
| | Ex. 1 | Ex. 2 | Ex. 3 | Ex. 4 | Ex. 5 | Ex. 6 |
| | (wt. %) | (wt. %) | (wt. %) | (wt. %) | (wt. %) | (wt. %) |
| PPS-1 | 56.9 | 61.2 | — | — | — | — |
| PPS-2 | — | — | 57.2 | 56.8 | — | — |
| PPS-3 | — | — | — | — | 57.2 | 56.8 |
| Silane | 0.3 | 0.3 | — | 0.4 | — | 0.4 |
| Coupling | | | | | | |
| Agent | | | | | | |
| Glass Fibers | 40 | 30 | 40 | 40 | 40 | 40 |
| Lubricant | 0.3 | — | 0.3 | 0.3 | 0.3 | 0.3 |
| Mold | — | 1 | — | — | — | — |
| Release Agent | | | | | | |
| Impact | — | 5 | — | — | — | — |
| Modifier | | | | | | |
| Black | 2.5 | 2.5 | 2.5 | 2.5 | 2.5 | 2.5 |
| Masterbatch | | | | | | |

Once formed, the resulting compositions were then injected molded and tested for various properties as described above. The results are set forth below.

| | Comp. | Comp. | Comp. | Comp. | Comp. | Comp. |
|---|---|---|---|---|---|---|
| | Ex. 1 | Ex. 2 | Ex. 3 | Ex. 4 | Ex. 5 | Ex. 6 |
| Crystallization | 220 | 217 | 228 | 223 | 225 | 223 |
| Temperature | | | | | | |
| (° C.) | | | | | | |
| Melt | 3.9 | 3.6 | 2.2 | 3.6 | 2.4 | 4.1 |
| Viscosity | | | | | | |
| (kPoise) | | | | | | |
| Tensile | 201 | 160 | 188 | 196 | 190 | 205 |
| Strength (MPa) | | | | | | |
| Tensile | 1.7 | 2.2 | 1.7 | 1.8 | 1.8 | 1.9 |
| Elongation | | | | | | |
| at Break (%) | | | | | | |
| Flexural | 15,260 | 10,259 | 15,484 | 15,472 | 15,202 | 16,057 |
| Modulus (MPa) | | | | | | |
| Flexural | 292 | 232 | 258 | 276 | 270 | 309 |
| Strength (%) | | | | | | |
| Charpy | 10.0 | 11.2 | 7.8 | 8.7 | 8.2 | 8.4 |
| Notched | | | | | | |
| (kJ/m²) | | | | | | |

### Examples 1-7

Examples 1-7 were melt mixed using a 32 mm Coperion co-rotating, fully-intermeshing, twin-screw extruder and include various concentrations of a polyarylene sulfide (PPS-1, PPS-2, and PPS-3), glass fibers, silane coupling agent, nucleating agent, and lubricant (Glycolube). The glass fibers were F-CR glass fibers obtained from 3B under the name “DS 8800-11P” (average fiber diameter of 11 μm).

| | Ex. | Ex. | Ex. | Ex. | Ex. | Ex. | Ex. |
|---|---|---|---|---|---|---|---|
| | 1 | 2 | 3 | 4 | 5 | 6 | 7 |
| | (wt. %) | (wt. %) | (wt. %) | (wt. %) | (wt. %) | (wt. %) | (wt. %) |
| PPS-1 | 56.9 | 61.2 | — | — | — | — | — |
| PPS-2 | — | — | 52.5 | 57.2 | 56.8 | — | — |
| PPS-3 | — | — | — | — | — | 57.2 | 56.8 |

What is claimed is:

1. A polymer composition comprising 100 parts by weight of a polymer matrix that contains a polyarylene sulfide and from about 30 parts by weight to about 120 parts by weight of inorganic fibers, wherein the polymer composition exhibits a peak crystallization temperature (T_{p,c}) of about 230° C. or more as determined by differential scanning calorimetry in accordance with ISO 11357-3:2018 and a tensile elongation of about 1.8% or more as determined at a temperature of 23° C. in accordance with ISO 527:2019.

2. The polymer composition of claim 1, wherein the polymer matrix constitutes from about 30 wt. % to about 80 wt. % of the polymer composition.

3. The polymer composition of claim 1, wherein the polyarylene sulfide is a polyphenylene sulfide.

4. The polymer composition of claim 1, wherein the polyarylene sulfide has a melt flow rate of from about 200 to about 700 g/10 min as determined in accordance with ISO 1133-1:2022 at a load of 5 kg and temperature of 316° C.

5. The polymer composition of claim 1, wherein the inorganic fibers include glass fibers.

6. The polymer composition of claim 5, wherein the glass fibers are generally free of boron.

7. The polymer composition of claim 5, wherein the glass fibers are E-CR glass fibers.

8. The polymer composition of claim 5, wherein the glass fibers contain silica in an amount of from about 57.5 wt. % to about 59.5 wt. %, alumina in an amount of from about 17 wt. % to about 20 wt. %, calcium oxide in an amount of from about 11 wt. % to about 13.5 wt. %, and magnesium oxide in an amount of from about 8.5 wt. % to about 12.5 wt. %.

9. The polymer composition of claim 1, wherein the inorganic fibers are coated with a sizing composition.

10. The polymer composition of claim 9, wherein the sizing composition contains an alkoxysilane.

11. The polymer composition of claim 9, wherein the sizing composition contains a functionalized compound.

12. The polymer composition of claim 11, wherein the functionalized compound includes a blocked isocyanate.

13. The polymer composition of claim 12, wherein the blocked isocyanate is capable of becoming deblocked at a temperature of from about 90° C. to about 210° C.

14. The polymer composition of claim 12, wherein the blocked isocyanate includes a blocked cycloaliphatic polyisocyanate.

15. The polymer composition of claim 9, wherein the sizing composition contains a film-forming agent.

16. The polymer composition of claim 9, wherein the coated inorganic fibers have a moisture content of about 0.5 wt. % or less.

17. The polymer composition of claim 1, further comprising from about 0.1 to about 8 parts by weight of an organosilane compound.

18. The polymer composition of claim 1, wherein the polymer composition exhibits a melt viscosity of about 5,000 poise or less as determined in accordance with ISO 11443:2021 at a temperature of about 310° C. and at a shear rate of 1,200 s⁻¹.

19. The polymer composition of claim 1, wherein the composition is free of boron nucleating agents.

20. A molded part comprising the polymer composition of claim 1.
